(19) United States
(12) Patent Application Publication
(10) Pub. No.: US 2018/0012327 A1
(43) Pub. Date: Jan. 11, 2018

(54) OVERLAYING MULTI-SOURCE MEDIA IN VRAM

(71) Applicant: Ubitus Inc., Grand Cayman (KY)

(72) Inventors: Chung-Chou Yeh, Taipei City (TW); Jing-Yu Li, Taipei City (TW); Guo-Chiuan Chen, Taipei City (TW)

(73) Assignee: Ubitus Inc., Grand Cayman (KY)

(21) Appl. No.: 15/202,080

(22) Filed: Jul. 5, 2016

(51) Int. Cl. G06T 1/20; G06T 11/60; G06T 1/60

(52) U.S. Cl. CPC G06T 1/20; G06T 1/60; G06T 11/60

(57) ABSTRACT

Methods, apparatuses, and computer program products for overlaying multisource media in VRAM are described.

### BACKGROUND

A platform, such as a cloud content platform, may need to deliver multiple multimedia content items to a target device simultaneously.

For example, a cloud gaming platform may need to stream a game scene with an advertisement to customers' devices. The game scene and the advertisement may come from different video sources. It may be desired that the advertisement is overlaid on the game scene, or that the game scene is underlaid beneath the advertisement.

The conventional overlay/underlay process may work like this: Capture a primary image from a primary video source, for example a game, and copy it to a frame buffer in System RAM. Then capture an overlay/underlay (second) image from the overlay/underlay (second) video source, for example an advertisement and blend the overlay/underlay image onto the primary image in the frame buffer. Finally, encode the new image in the frame buffer into the target video. The capturing, copying, and blending require significant extra effort by the system. System bus, system memory, and CPU resources are impacted. In a high CCU (concurrent user) system, this extra effort can cause low performance and high power consumption by the server.

Therefore, a new and improved system and method is desired to provide a more efficient overlay/underlay process.

### SUMMARY

Embodiments of the present invention provide systems and methods for efficiently overlaying multimedia content on a video source generated by an application program.

Embodiments of the present invention also provide systems and methods for efficiently underlaying multimedia content beneath such a video source, or for blending multimedia content with the video source.

According to embodiments of the present invention, there is provided a multimedia content processing system and a multimedia content processing method, which perform the overlay/underlay in VRAM, thereby reducing system bus, system memory, and CPU usage.

In embodiments of the inventive system and method, the primary source is rendered in VRAM by an application program, and then the overlay/underlay source(s) are rendered and blended to the primary source in VRAM at a specified time and position.

The blending is performed at the same location of the primary source in VRAM, so no extra buffer is needed. This improves system performance and reduces power consumption, through reduced system bus, system memory, and CPU usage.

The overlay/underlay result is sent to a video back buffer or frame buffer and then encoded and sent to system RAM, directly presented on a display device, or fed back to the same VRAM location as part of an iterative overlay process.

### BRIEF DESCRIPTION OF THE DRAWINGS

FIG. 1 is a block diagram of a distributed client-server computer system 1000 supporting interactive multisource multimedia applications according to one embodiment of the present invention.

FIG. 2 is a system architecture diagram of a video processing system, in which an embodiment of the present invention may be implemented, comprising a Graphics Processing Unit (GPU) and Video Random Access Memory (VRAM).

FIG. 3 is a block diagram of a system for overlaying multimedia contents on a primary source, in accordance with an embodiment of the present invention.

FIG. 4 is a flow diagram of a method for overlaying multimedia contents on a primary source, in accordance with an embodiment of the present invention.

### DETAILED DESCRIPTION

Embodiments of the present invention provide a system and method to overlay/underlay multimedia contents on a video source generated by an application program without requiring an extra buffer.

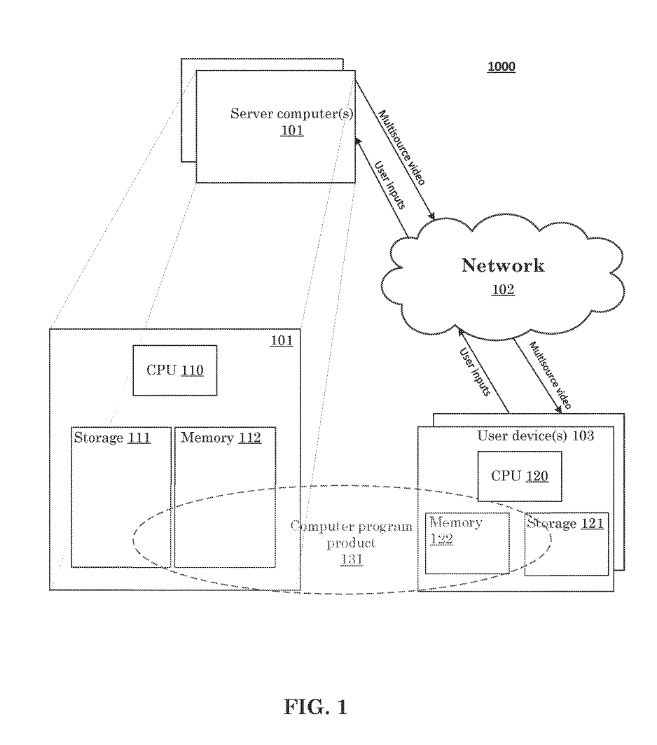

FIG. 1 is a block diagram of a distributed client-server computer system 1000 supporting multimedia applications according to one embodiment of the present invention. Computer system 1000 includes one or more server computers 101 and one or more user devices 103 configured by a computer program product 131. Computer program product 131 may be provided in a transitory or non-transitory computer readable medium; however, in a particular embodiment, it is provided in a non-transitory computer readable medium, e.g., persistent (i.e., non-volatile) storage, volatile memory (e.g., random access memory), or various other well-known non-transitory computer readable mediums.

User device 103 includes central processing unit (CPU) 120, memory 122 and storage 121. User device 103 also includes an input and output (I/O) subsystem (not separately shown in the drawing) (including e.g., a display or a touch enabled display, keyboard, d-pad, a trackball, touchpad, joystick, microphone, and/or other user interface devices and associated controller circuitry and/or software). User device 103 may include any type of electronic device capable of providing media content. Some examples include desktop computers and portable electronic devices such as mobile phones, smartphones, multi-media players, e-readers, tablet/touchpad, notebook, or laptop PCs, smart televisions, smart watches, head mounted displays, and other communication devices.

Server computer 101 includes central processing unit CPU 110, storage 111 and memory 112 (and may include an I/O subsystem not separately shown). Server computer 101 may be any computing device capable of hosting computer product 131 for communicating with one or more client computers such as, for example, user device 103, over a network such as, for example, network 102 (e.g., the Internet). Server computer 101 communicates with one or more client computers via the Internet and may employ protocols such as the Internet protocol suite (TCP/IP), Hypertext Transfer Protocol (HTTP) or HTTPS, instant-messaging protocols, or other protocols.

Memory 112 and 122 may include any known computer memory device. Storage 111 and 121 may include any known computer storage device.

Although not illustrated, memory 112 and 122 and/or storage 111 and 121 may also include any data storage equipment accessible by the server computer 101 and user device 103, respectively, such as any memory that is removable or portable, (e.g., flash memory or external hard disk drives), or any data storage hosted by a third party (e.g., cloud storage), and is not limited thereto.

User device(s) 103 and server computer(s) 101 access and communicate via the network 102. Network 102 includes a wired or wireless connection, including Wide Area Networks (WANs) and cellular networks or any other type of computer network used for communication between devices.

In the illustrated embodiment, computer program product 131 in fact represents computer program products or computer program product portions configured for execution on, respectively, server 101 and user device 103.

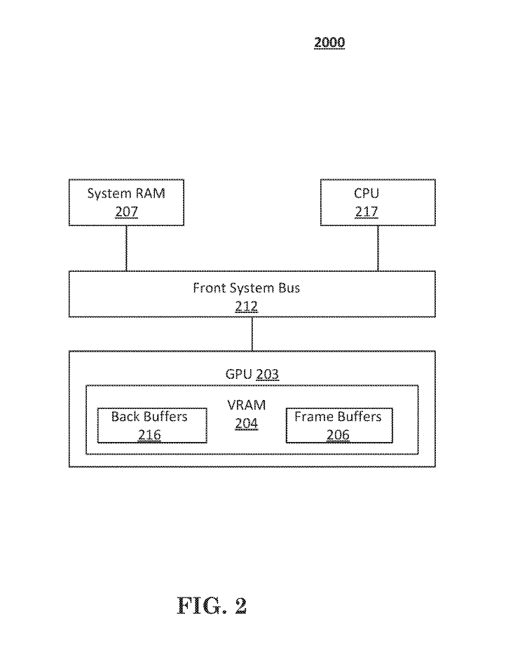

FIG. 2 is a system architecture diagram of a video processing system 2000. Embodiments of video processing system 2000 comprise system elements that are optimized for video processing, in particular including a Graphics Processing Unit (GPU) 203 and Video Random Access Memory (VRAM) 204.

In some embodiments, video processing system 2000 also includes conventional computing elements that are not necessarily optimized for video processing, such as CPU 217 and System RAM 207.

In some embodiments, VRAM 204 comprises one or more buffers, such as Frame Buffers 206 and/or Back Buffers 216. In general, a Frame Buffer 206 is a region in memory large enough to store a complete frame of video data. Frame buffers can also be defined in other memory elements, such as System RAM 207. In some embodiments, additional buffers such as Back Buffers 216 may be provided by, for example, defining a suitable memory region in VRAM 204. In some embodiments, one or more Back Buffers 216 may be provided to support a double buffering function, in order to reduce flickering in a video display. In some embodiments, Back Buffers 216 may serve to store the results of rendering and/or blending operations, as further described below.

Video processing system 2000 may further comprise one or more interconnect mechanisms or buses, such as Front System Bus 212, in order to directly or indirectly interconnect entities such as GPU 203, VRAM 204, CPU 217, and System RAM 207.

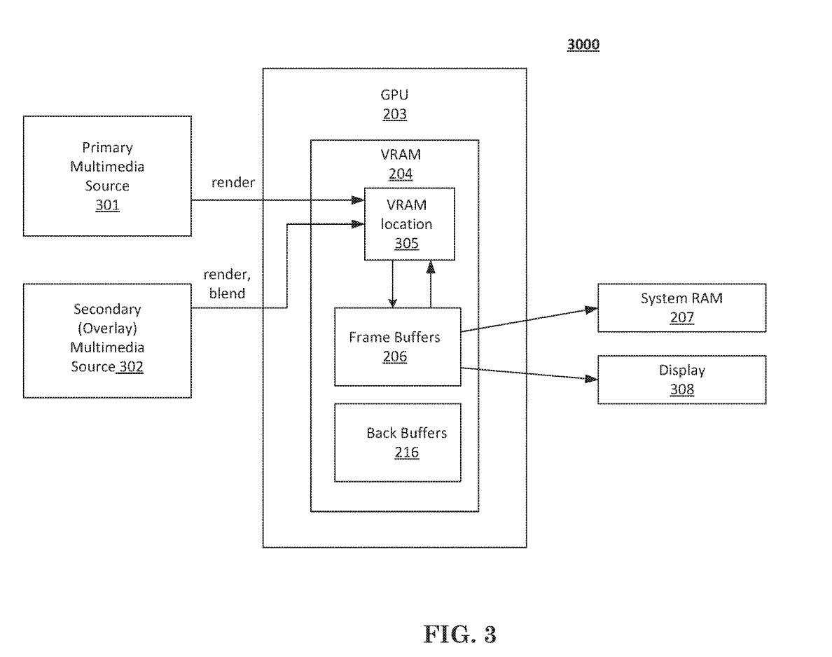

FIG. 3 is a high-level block diagram of a system 3000 for overlaying multisource media according to some embodiments of the present invention.

In the depicted embodiment of system 3000, Graphics Processing Unit (GPU) 203 comprises Video Random Access Memory (VRAM) 204 which in turn comprises Frame Buffer(s) 206. In general, Frame Buffer 206 is a region in memory large enough to store a complete frame of video data. VRAM 204 may comprise more than one Frame Buffer 206. As noted above, frame buffers can also be defined in other memory elements, such as System RAM 207.

In some embodiments, the processes described herein may be performed in a digital device comprising memory and a processing unit that is not described as a GPU or is actually not a GPU. In some embodiments, the GPU is part of a server. In some embodiments a server comprising a GPU is a cloud-based server. In some embodiments the GPU is part of a client device.

Primary Source 301 comprises, for example, graphics objects such as vertexes, texture, shading, mesh, etc. In a preferred embodiment, Primary Source 301 is generated by an application program and is directly rendered in VRAM 204 at VRAM location 305. In some embodiments, VRAM Location 305 comprises one of Back Buffers 216. In another embodiment, VRAM Location 305 comprises Frame Buffer 206. In one embodiment, Primary Source 301 is output from a game application. Because Primary Source 301 is directly rendered in VRAM 204, no resources need be expended in “capturing” Primary Source 301. In other embodiments, Primary Source 301 is rendered elsewhere and copied into VRAM 204.

Secondary Multimedia Source 302 can be an item of visual or multimedia content that is to be overlaid on Primary Source 301. In an embodiment, Secondary Multimedia Source 302 comprises graphics objects such as vertexes, texture, shading, mesh, etc. In one embodiment, Secondary Source 302 is generated by an application program and is directly rendered in VRAM 204. In some embodiments, Secondary Source 302 is rendered in VRAM Location 305. In some embodiments, Secondary Source 302 is generated by the same application program that generates Primary Source 301. In other embodiments, Secondary Source 302 is generated by a different application program. In still other embodiments, Secondary Source 302 can be the output of a hardware device such as a TV card. In such embodiments it may be necessary to capture Secondary Source 302 in System RAM 207 and upload it to VRAM Location 305.

In one example, Secondary Multimedia Source 302 is an advertisement that is to be overlaid on Primary Source 301. In other embodiments, Secondary Multimedia Source 302 is to be underlaid under Primary Source 301. In other embodiments, Secondary Multimedia Source 302 is to be blended with Primary Source 301 in an intermediate manner, so that, for example, both sources are visible to some degree.

In VRAM 204, one or more secondary sources 302 are blended with Primary Source 301 at a specified time and position. In some embodiments, Primary Source 301 provides time and position references to Secondary Source 302. In some embodiments, blending takes place at the same VRAM location 305 in VRAM 204 where Primary Source 301 was rendered, so no extra buffer need be used for the blending process. In some embodiments, rendering of Primary Source 301, rendering of Secondary Source 302, and blending of Primary Source 301 and Secondary Source 302 to produce a target image all take place in the same VRAM location 305. In some embodiments, rendering of Primary Source 301 and Secondary Source 302 in the same location accomplishes the desired blending, and there is no separate blending step.

After the blending process completes, in some embodiments, the target image produced by the blending process is sent to Frame Buffer 206. In some embodiments, where rendering and blending take place in Frame Buffer 206, the target image will already be in Frame Buffer 206. As a next step, the target image can be encoded to form part of the target video. The target video can then be sent to System RAM 207. In some embodiments, the target video may be sent to one of Back Buffers 216. In other embodiments, the target video may be sent directly to Display 308. In other embodiments, the target video may be rendered back to VRAM Location 305 in an iterative process, for example to accomplish multiple overlays. This option is depicted in FIG. 3 as a data path back to VRAM location 305 from Frame Buffer 206. Multiple overlays may be used, for example, to render a 3D surface or texture.

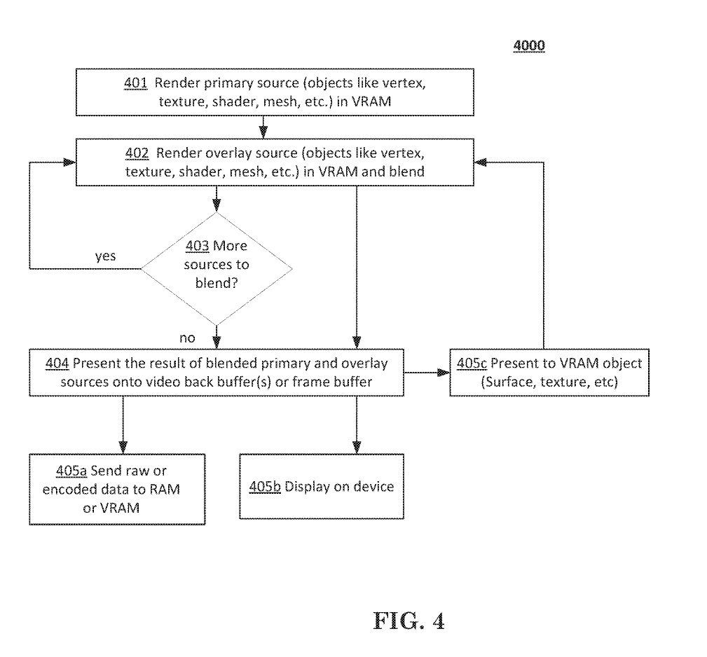

FIG. 4 illustrates a process 4000 for overlaying multisource media according to some embodiments of the present invention.

In step 401, a primary source, comprising objects such as vertexes, texture, shading, or a mesh is rendered in VRAM. In step 402, an overlay/underlay source is also rendered in VRAM and is blended with the primary source in the same VRAM location. In some embodiments, the VRAM location will correspond to one of Back Buffers 216. In some embodiments, the VRAM location will correspond to one or more of Frame Buffers 206. In other embodiments, the VRAM location will correspond to another location, different from a back buffer or frame buffer location. In at least some embodiments, rendering of the primary source and overlay/underlay source in the same location accomplishes the desired blending, and there is no separate blending step.

If there are more overlay/underlay sources, steps 402 and 403 will be repeated until all overlay/underlay sources are rendered and blended.

In step 404, the overlay/underlay result is presented in a video back buffer(s) or a frame buffer. In embodiments where the blending process takes place in a back buffer or frame buffer, step 404 may involve little or no additional work. In other embodiments, step 404 comprises sending the overlay/underlay result from VRAM Location 305 to a back buffer or frame buffer.

Steps 405a, 405b, and 405c illustrate alternative next steps of process 4000. At 405a, encoded video or raw video data is sent to system RAM or to VRAM. Raw video data might be output, for example, for a follow-on software encoding step (not shown) in the case where the GPU does not support a specific encoding format. At 405b, the overlay/underlay result is directly presented on a display device. At 405c, the overlay/underlay result is fed back to step 402 one or more times in order to accomplish multiple overlays through an iterative process.

Although a few exemplary embodiments have been described above, one skilled in the art will understand that many modifications and variations are possible without departing from the spirit and scope of the present invention. Accordingly, all such modifications and variations are intended to be included within the scope of the claimed invention.

1. In a Graphics Processing Unit (GPU), a method comprising:
rendering a primary image graphically generated by and directly rendered from a first application program in a Video Random Access Memory (VRAM) first buffer;
rendering a secondary image graphically generated by and directly rendered from a second application program in the VRAM first buffer, thereby overlaying the secondary image on the primary image in the VRAM first buffer; and
presenting, in a second buffer, a result of overlaying the secondary image on the primary image.

2. The method of claim 1 wherein the second buffer comprises one or more video back buffers.

3. The method of claim 1 wherein the second buffer is a frame buffer.

4. The method of claim 1 further comprising encoding the overlaying result and storing the encoded overlaying result in VRAM or in a System Random Access Memory (System RAM).

5. The method of claim 1 further comprising displaying the overlaying result on a display.

6. The method of claim 5 wherein the display is a user device display.

7. The method of claim 1 wherein the overlaying result is rendered back to the VRAM first buffer.

8. The method of claim 1 wherein a primary source of the primary image provides time and position references to one or more secondary sources.

9. The method of claim 1 wherein the overlaying takes place at a specified time and at selected positions on the primary image.

10. The method of claim 1 further comprising overlaying one or more additional images onto the primary or secondary image.

11. A system for efficient overlaying of multimedia sources, comprising:
a Graphics Processing Unit (GPU) comprising Video Random Access Memory (VRAM) and one or more frame buffers;
a display;
and System Random Access Memory (System RAM),
the GPU being configured to:
render a primary image graphically generated by and directly rendered from a first application program in a VRAM first buffer;
render a secondary image in the VRAM first buffer;
overlay the secondary image onto the primary image in the VRAM first buffer, producing an overlaying result; and
store the overlaying result in a frame buffer or video back buffer.

12. The system of claim 11, wherein the GPU is further configured to overlay one or more additional images onto the primary and secondary images.

13. The system of claim 11, wherein the GPU is further configured to display the overlaying result in the display.

14. The system of claim 11, wherein the GPU is further configured to encode the overlaying result and store it in System RAM.

15. The system of claim 11, wherein the overlaying result is rendered back to the VRAM first buffer.

16. The system of claim 11, wherein a primary source of the primary image provides time and position references to a secondary source of the secondary image.

17. The system of claim 11, wherein the overlaying takes place at a specified time and at selected positions on the primary image.

18. The system of claim 11, wherein overlaying the secondary image onto the primary image comprises overlaying the primary and secondary images so that both images are partly visible.

19. The system of claim 11, wherein the GPU is configured to produce an overlaying result by rendering the primary and secondary images in the VRAM first buffer, without performing a separate overlaying step.

20. A computer program product in a non-transitory computer-readable medium comprising instructions executable by a computer processor to:
render a primary image graphically generated by and directly rendered from a first application program in a Video Random Access Memory (VRAM) first buffer;
render a secondary image graphically generated by and directly rendered from a second application program in the VRAM first buffer;
overlay the secondary image onto the primary image in the VRAM first buffer; and
present a result of overlaying the secondary image onto the primary image in a second buffer.
